(19) United States
(12) Patent Application Publication
(10) Pub. No.: US 2025/0180072 A1
(43) Pub. Date: Jun. 5, 2025

(54) OPTIMIZED FACE-MOUNTED ANGULAR CONTACT BALL BEARING

(71) Applicant: AKTIEBOLAGET SKF, GOTEBORG (SE)

(72) Inventor: William D. SCHMIDT, Muskegon, MI (US)

(21) Appl. No.: 18/524,028

(22) Filed: Nov. 30, 2023

(51) Int. Cl. F16C 33/58; F16C 19/18; F16C 33/32

(52) U.S. Cl. CPC F16C 33/585; F16C 19/184; F16C 33/32

(57) ABSTRACT

A face-mounted angular contact ball bearing includes an inner ring with an axial end connectable with a first member and an outer surface including axially spaced first and second inner raceways. An outer ring is disposed about the inner ring and has an axial end connectable with a second member and an inner surface including first and second outer raceways disposed axially between and facing the inner raceways. A first set of balls is disposed between the first inner and outer raceways and a second set of balls is disposed between the second inner and outer raceways. The inner and outer rings and the two sets of balls are formed such that the contact angles of each set of balls is greater than thirty-five degrees, preferably between forty and sixty degrees. Also, the number of the balls of each ball set provides a bearing fill percentage greater than seventy-five percent.

### BACKGROUND OF THE INVENTION

The present invention relates to bearings, and more particularly to angular contact ball bearings.

Angular contact ball bearings are known and are formed to support both axial and radial loading. An angular contact bearing includes an inner ring, an outer ring disposed about the inner ring, and one or more rows or sets of balls disposed between the inner and outer rings. The raceways of the two rings, as well as the relative radial sizing of the rings, are formed such that each ball contacts the raceways at an angle with respect to a vertical plane. As such, the angular contact bearing is capable of supporting and transferring axial loads between the inner and outer rings, and thereby between two members coupled by the bearing. Typically, the inner ring is disposed about an inner member, such as a shaft or axle, and the outer ring is disposed within a cylindrical surface of an outer member, which may be a hub, a housing, etc.

### SUMMARY OF THE INVENTION

In one aspect, the present invention is a face-mounted angular contact ball bearing assembly for rotatably coupling a first member and a second member. The ball bearing assembly comprises an inner ring having a centerline, opposing first and second axial ends, one of the first and second axial ends being connectable with the first member, an inner circumferential surface and an outer circumferential surface including a first inner raceway and a second inner raceway spaced axially from and facing the first inner raceway. An outer ring is disposed about the inner ring and has opposing first and second axial ends, one of the first and second axial ends being connectable with the second member, an outer circumferential surface and an inner circumferential surface including a first outer raceway and a second outer raceway. The first and second outer raceways are disposed axially between the first and second inner raceways such that the first outer raceway faces the first inner raceway and the second outer raceway faces the second inner raceway. A first set of balls is disposed between the first inner raceway and the first outer raceway and a second set of balls is disposed between the second inner raceway and the second outer raceway, each ball of the first and second sets of balls having a ball diameter.

Further, the inner ring, the outer ring, the first set of balls and the second set of balls are each configured and sized such that a first contact angle between each ball of the first set of balls and the first inner and outer raceways has a value greater than thirty-five degrees and a second contact angle between each ball of the second set of balls and the second inner and outer raceways has a value greater than thirty-five degrees. Also, a number of the balls of each one of the first and second sets of balls provides a bearing fill percentage of greater than seventy-five percent.

Preferably, each contact angle has a value between forty and sixty percent and the fill percentage is greater than eighty percent. Also, each one of the inner and outer rings preferably has annular shoulder(s) providing at least a major portion of a separate one of the first and second inner raceways, each shoulder having a radial height with respect to the remainder of the outer or inner circumferential surface and the radial height having a value of at least forty percent of the ball diameter.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is broken-away, axial cross-sectional view of an upper portion of a bearing assembly in accordance with the present invention, shown rotatably coupling first and second members;

FIG. 2 is a side plan view of the bearing assembly;

FIG. 3 is a broken-away, axial cross-sectional view of the bearing assembly;

FIG. 4 is an enlarged, broken-away axial cross-sectional view of the bearing assembly, showing the raceways and contact angles;

FIG. 5 is broken-away, axial cross-sectional view of an upper portion of an inner ring of the bearing assembly;

FIG. 6 is an enlarged view of a portion of FIG. 5, showing the details of the inner raceways;

FIG. 7 is broken-away, axial cross-sectional view of an upper portion of an outer ring of the bearing assembly;

FIG. 8 is an enlarged view of a portion of FIG. 7, showing the details of the outer raceways;

FIG. 9 is a broken-away, axial cross-sectional view of the bearing assembly, shown with a one-piece outer ring; and

FIG. 10 is another axial cross-sectional view of an upper portion of a bearing, shown rotatably coupling first and second members through intermediate members.

### DETAILED DESCRIPTION OF THE INVENTION

Certain terminology is used in the following description for convenience only and is not limiting. The words “lower”, “upper”, “upward”, “down” and “downward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

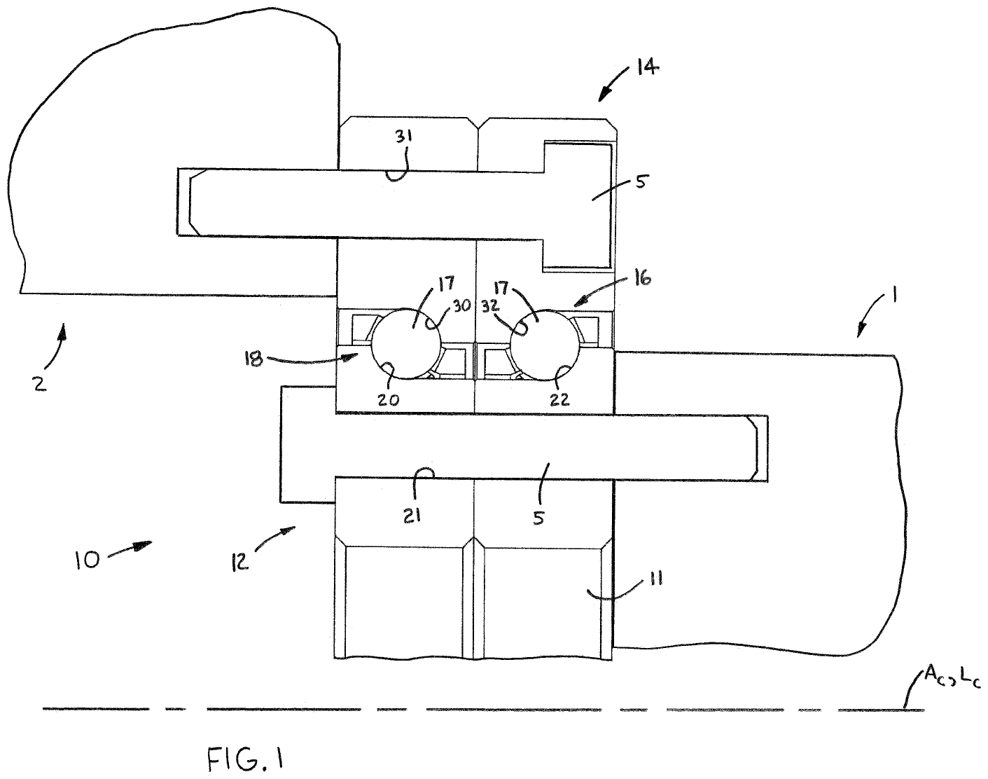

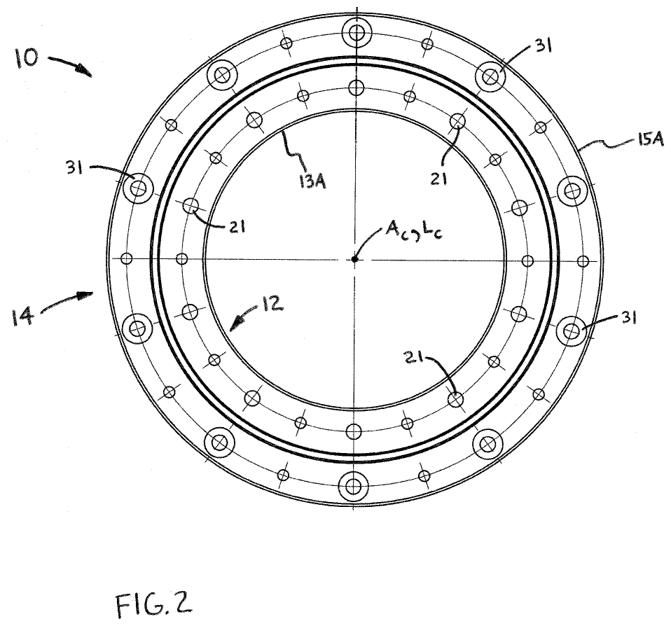

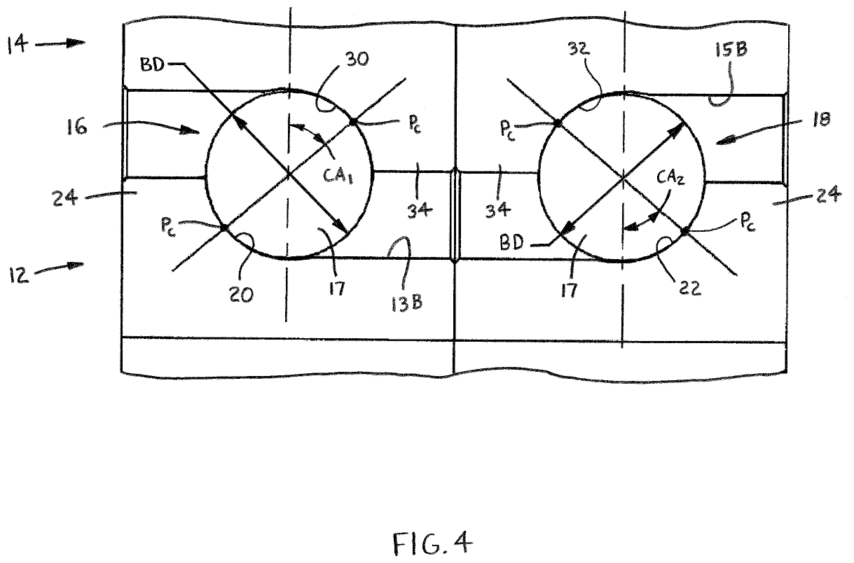

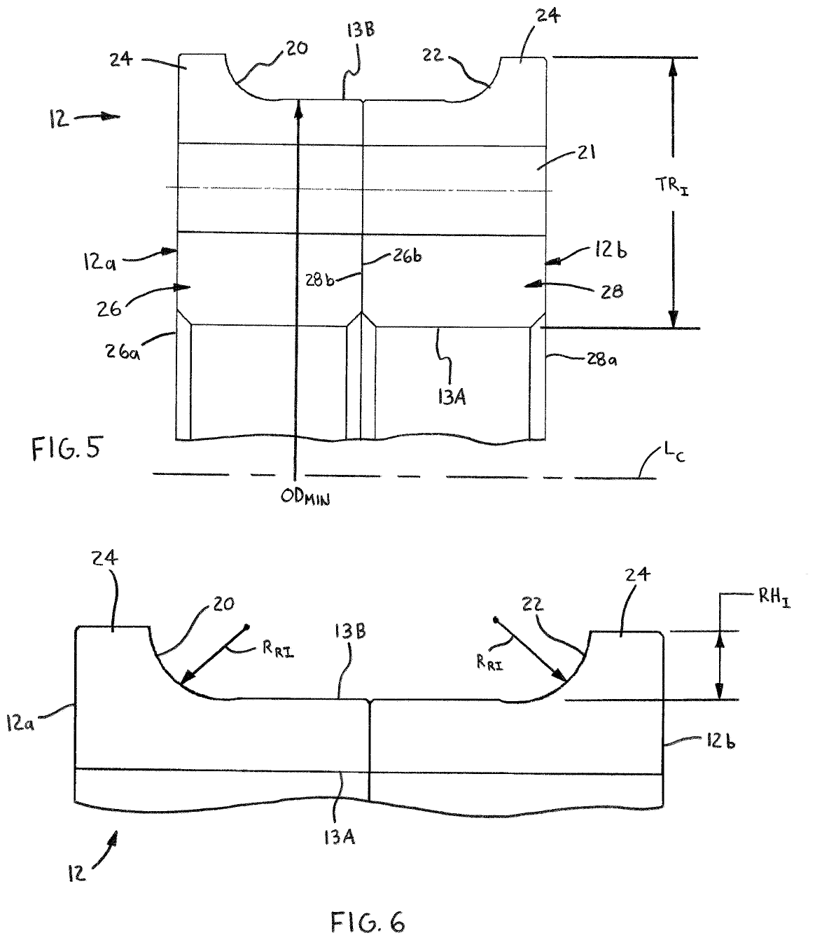

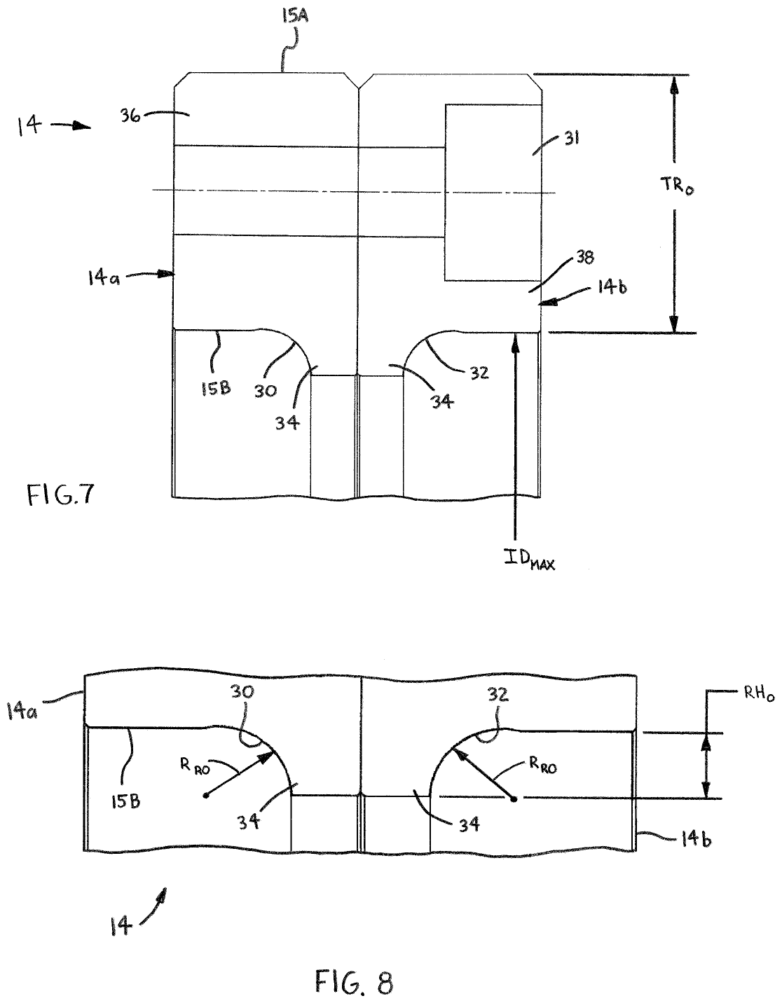

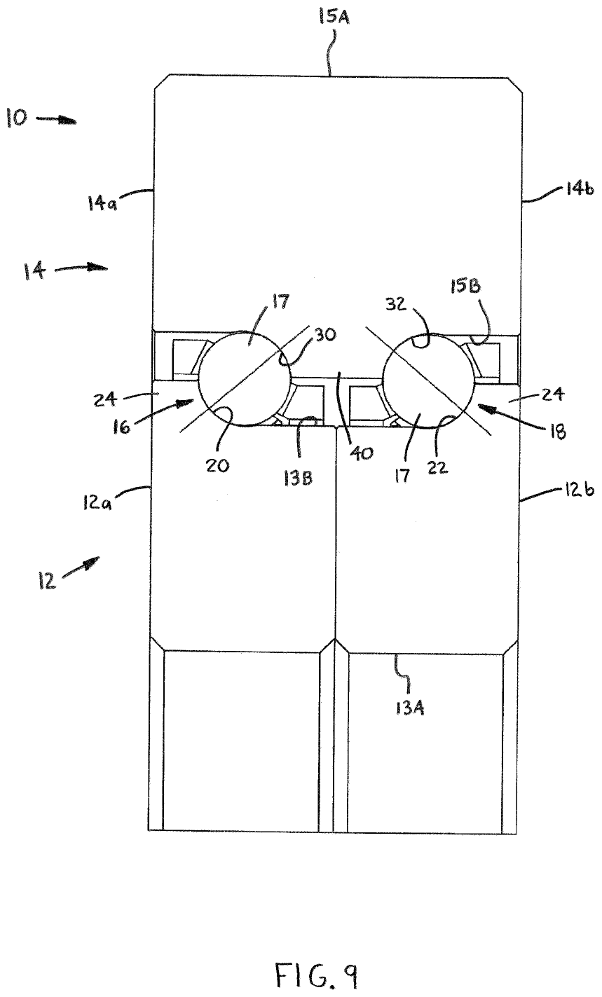

Referring now to the drawings in detail, wherein like numbers are used to indicate like elements throughout, there is shown in FIGS. 1-10 a face-mounted angular contact ball bearing assembly 10 for rotatably coupling a first member 1 and a second member 2 such that at least one member 1, 2 rotates about a central axis A_{C}. The first and second members 1, 2 are preferably separate components of a joint of a robotic machine, such as a shoulder and an arm of a joint of a robotic handler used in the semiconductor manufacturing industry, but may be components of any other appropriate mechanical assembly in which it is desired to rotatably couple two members 1, 2 with maximum load capacity and stiffness. In any case, the angular contact ball bearing assembly basically comprises an inner ring 12, an outer ring 14 disposed about the inner ring 12, a first set 16 of balls 17 and a second set 18 of the balls 17, each ball set 16, 18 being rollably disposed between the inner and outer rings 12, 14. Due to the arrangement of the raceways and the configuration and sizing of the inner and outer rings 12, 14 and the diameter BD (FIG. 4) of the balls 17, the face-mounted angular contact bearing assembly 10 has a substantially greater stiffness and capability of supporting axial and moment loads as compared to previous known bearings used for such applications, as described in detail below.

Referring first to FIGS. 1 and 4-6, the inner ring 12 has a centerline L_{C}, which is coaxial with the central axis A_{C}, opposing first and second axial ends 12a, 12b, an inner circumferential surface 13A defining a central bore 11, an opposing outer circumferential surface 13B, and a radial thickness TR_{I} (FIG. 5) between a minimum outside diameter ODMIN of the outer surface 13B and the inner surface 13A. One of the first and second axial ends 12a, 12b of the inner ring 12 is mountable to or connectable with the first member 1 such that the inner ring 12 is “face mounted” to the first member 1, and the one end 12a or 12b is either directly disposed against the first member 1 or against an intermediate member 3 (e.g., a spacer; FIG. 10) located between the inner ring 12 and the first member 1. Preferably the inner ring 12 has a plurality of mounting holes 21 extending axially from one of the first and second axial ends 12a, 12b and spaced circumferentially about the centerline L_{C}, each mounting hole 21 being configured to receive a fastener with clearance or to be threadably engaged by a fastener 5 (FIG. 1) so as to connect the inner ring 12 with the first member 1, either directly or through the intermediate member 3, as shown in FIG. 10.

Further, the outer circumferential surface 13B includes a first inner raceway 20 and a second inner raceway 22 spaced axially from and facing the first inner raceway 20. Preferably, each one of the first and second inner raceways 20, 22 has a radius R_{RI} (FIG. 6) with a value of no more than three percent greater than half the value of the ball diameter BD, for reasons discussed below. More specifically, the inner ring 12 includes two annular shoulders 24 extending radially outwardly from a remainder of the outer circumferential surface 13B of the inner ring 12 and are spaced axially apart. Each annular shoulder 24 provides at least a major portion of a separate one of the first and second inner raceways 20, 22, i.e., at least seventy-five percent and preferably more than ninety percent of the total raceway surface area, and has a radial height RH_{I} with respect to the remainder of the outer circumferential surface 13B. The two shoulders 24 are sized such that the radial height RH_{I} has a value of at least forty percent of the ball diameter BD and preferably about forty-eight percent of the ball diameter BD, so as to enable the bearing assembly 10 to be formed with a substantially large contact angle as discussed below.

Further, the inner ring 12 is preferably a two-part ring that includes a first ring part 26 and second ring part 28, the two ring parts 26, 28 axially abutting. Specifically, the first ring part 26 provides the first inner raceway 20 and has an outer axial end 26a providing the inner ring first axial end 12a and an opposing inner axial end 26b and the second ring part 28 provides the second inner raceway 22 and has an outer axial end 28a providing the inner ring second axial end 12b and an inner axial end 28b disposed against the inner axial end 26b of the first ring part 26.

Referring now to FIGS. 1, 4, 7 and 8, the outer ring 14 has opposing first and second axial ends 14a, 14b, an outer circumferential surface 15A, an opposing inner circumferential 15B and a radial thickness TR_{O} (FIG. 7) between a maximum inside diameter ID_{MAX} of the inner surface 15B and the outer surface 15A. One of the first and second axial ends 14a or 14b is connectable with the second member 2 so as to be face-mounted as discussed with the inner ring 12, and is either directly disposed against a radial surface 2a of the second member 2 or against an intermediate member 4 (FIG. 10) located between the outer ring 14 and the second member 2. Preferably, a plurality of mounting holes 31 extend axially from one of the first and second axial ends 14a, 14b and are spaced circumferentially about the centerline L_{C}, each mounting hole 31 being configured to receive a fastener (none shown) with clearance, or to be threadably engaged by a fastener, so as to connect the outer ring 14 with the second member 2, either directly or through the intermediate member 4.

Further, the inner circumferential surface 15B of the outer ring 14 includes a first outer raceway 30 and a second outer raceway 32, the first and second outer raceways 30, 32 being disposed axially between the first and second inner raceways 20, 22. Specifically, the two outer raceways 30, 32 are arranged such that the first outer raceway 30 faces the first inner raceway 20, as well as the outer ring first axial end 14a, and the second outer raceway 32 faces the second inner raceway 22 and the outer ring second axial end 14b. As such, the four raceways 20, 22, 30, 32 are arranged in a “back-to-back” configuration in which the contact angles, as described below, intersect the axis of rotation AR externally of the bearing assembly 10, as discussed in further detail below. Preferably, as with the inner ring 12, each one of the first and second outer raceways 30, 32 is preferably formed with a radius R_{RO} (FIG. 8) having a value of no more than three percent greater than half the value of the ball diameter BD, as also discussed below.

Referring to FIGS. 7 and 8, the outer ring 14 preferably includes two adjacent annular shoulders 34 extending radially inwardly from a remainder of the inner circumferential surface 15B of the outer ring 14. Each annular shoulder 34 provides at least a major portion of a separate one of the first and second outer raceways 30, 32, i.e., at least seventy-five percent and preferably more than ninety percent of the total raceway surface area, and has a radial height RH_{O} with respect to the remainder of the inner circumferential surface 15B. Further, the outer ring 14 has the two adjacent shoulders 34 when the outer ring 14 is formed as two ring parts 36, 38, as depicted in FIGS. 4, 7 and 8.

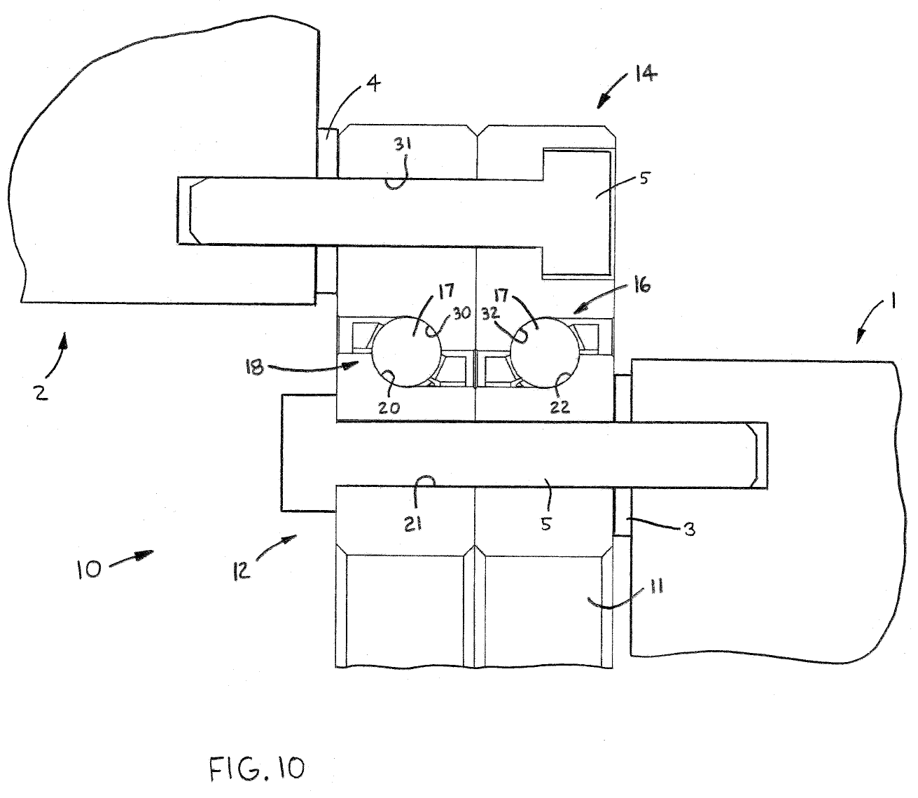

Referring particularly to FIG. 9, the outer ring 14 may alternatively formed as a single ring having a single annular shoulder 40 extending radially inwardly from a central portion of the inner circumferential surface 15B, which provides at least a major portion of both of the first and second outer raceways 32, 34 on opposing axial sides 40a, 40b of the shoulder 40. The single shoulder 40 has a radial height RH_{O} with respect to the remainder of the inner circumferential surface 15B. In either case, the radial height RH_{O} of each one of the two shoulders 34 or the single shoulder 40 of the outer ring 14 has a value of at least forty percent of the ball diameter BD, and preferably greater than forty-eight percent of the ball diameter BD, to allow a relatively large contact angle to be formed as discussed below.

Further, the first set 16 of balls 17 are disposed between the first inner raceway 30 and the first outer raceway 40 and the second set 18 of balls 17 are disposed between the second inner raceway 32 and the second outer raceway 34, and the two sets 16, 18 of balls 17 are spaced circumferentially apart about the centerline Le of the inner ring 12. Each ball 17 of the two ball sets 16, 18 preferably has a ball diameter BD with the same value, but in certain applications, the balls 17 of one set 16, 18 may have a greater or smaller diameter BD than the balls 17 of the other ball set 18, 16.

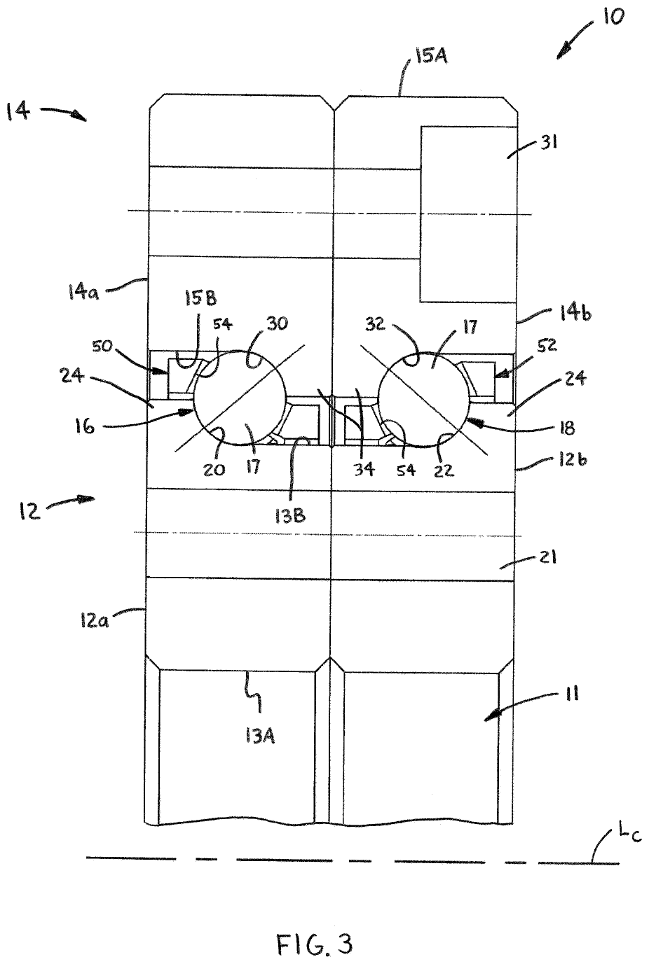

Referring particular to FIG. 3, the bearing assembly 10 preferably further comprises first and second annular cages 50, 52 each disposed between the inner and outer rings 12, 14 and having a plurality of pockets 54 spaced circumferentially about the centerline L_{C}. Each pocket 54 of the first cage 50 contains a separate one of the balls 17 of the first set 16 of balls 17 and each pocket 54 of the second cage 52 contains a separate one of the balls 17 of the second set 18 of balls 17. Further, each cage 50, 52 is angled such that each cage 50, 52 has an outer axial end disposed between the inner surface 15B of the outer ring 14 and one shoulder 24 of the inner ring 12 and an inner axial end disposed between the outer surface 13B of the inner ring 12 and either one shoulder 34 of the outer ring 14 or the single central shoulder 40 of the outer ring 14.

With the basic structure as described above, the inner ring 12, the outer ring 14 and each ball 17 of the two sets of balls 16, 18 are each formed and sized such that a first contact angle CA₁ (FIG. 4) between a contact point P_{C} of each ball 17 of the first set 16 of balls 17 on the first inner and outer raceways 20, 30 has a value greater than thirty-five degrees and a second contact angle CA₂ (FIG. 4) between a contact point P_{C} of each ball 17 of the second set 18 of balls 17 on the second inner and outer raceways 22, 32 has a value greater than thirty-five degrees. Specifically, each contact angle CA₁, CA₂ is established by the relative radial sizing between the inner ring 12 and the outer ring 14 for a given diameter BD of the balls 17, which establishes an amount of radial clearance, and the relatively large radial height RH_{I}, RH_{O} of the ring shoulders 24, 34 or 40, respectively, as well as the axial spacing between the raceways 20, 22 and 30, 32. Preferably, each one of the inner and outer rings 12, 14 are radially sized and formed with specific values of the shoulder heights RH_{I}, RH_{O}, as well as the particular values of the ball diameter BD and the raceway radii R_{RI}, R_{RO}, such that each contact angle CA₁, CA₂ is between forty degrees and sixty degrees.

Further, a particular number of the balls 17 of each one of the first and second sets 16, 18 of balls 17 is selected or specified to provide a bearing fill percentage of greater than seventy-five percent, and preferably greater than eighty percent. As is known, the fill percentage of a bearing is the percentage of the circumference of the pitch circle of the bearing that is occupied by all of the balls of a ball set, the pitch circle being a theoretical circle through the center of all of the balls of the ball set and about which each ball travels during bearing rotation. Furthermore, each one of the inner ring 12 and the outer ring 14 are specifically radially sized such that a value of each radial thickness RT_{I}, RT_{O} is at least two times greater than a value of the ball diameter BD, and preferably the value of each radial thickness RT_{I}, RT_{O} is at least three times greater than the ball diameter value.

With the combination of the relatively large contact angles CA₁, CA₂, the substantial bearing fill percentage and the relatively large radial thickness RT1, RT2 of the rings 12, 14, the face-mounted angular contact bearing 10 has significant stiffness and the capability of handling increased axial and moment loads. More specifically, the relative high contact angles CA₁, CA₂ substantially increases the stiffness of the bearing assembly 10 under relatively heavy axial and moment loads. The high fill percentage of the two sets 16, 17 of the balls 17 also increases stiffness of the bearing assembly 10 and reduces that contact stresses on each ball 17, leading to greater life of the balls 17 and thereby also of the bearing assembly 10. Further, the shoulders 24 and 34 or 40 having a substantial radial height provides a relatively large contact surface area for the balls 17 in the direction of axial thrust loads, which increases moment stiffness and reduces contact stress due to axial thrust loads.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

I claim:

1. A face-mounted angular contact ball bearing assembly for rotatably coupling a first member and a second member, the ball bearing assembly comprising:
an inner ring having a centerline, opposing first and second axial ends, one of the first and second axial ends being connectable with the first member, an inner circumferential surface and an outer circumferential surface including a first inner raceway and a second inner raceway spaced axially from and facing the first inner raceway;
an outer ring disposed about the inner ring and having opposing first and second axial ends, one of the first and second axial ends being connectable with the second member, an outer circumferential surface and an inner circumferential surface including a first outer raceway and a second outer raceway, the first and second outer raceways being disposed axially between the first and second inner raceways such that the first outer raceway faces the first inner raceway and the second outer raceway faces the second inner raceway; and
a first set of balls disposed between the first inner raceway and the first outer raceway and a second set of balls disposed between the second inner raceway and the second outer raceway, each ball of the first and second sets of balls having a ball diameter;
wherein the inner ring, the outer ring, the first set of balls and the second set of balls are each configured and sized such that a first contact angle between each ball of the first set of balls and the first inner and outer raceways has a value greater than thirty-five degrees and a second contact angle between each ball of the second set of balls and the second inner and outer raceways has a value greater than thirty-five degrees; and
wherein a number of the balls of each one of the first and second sets of balls provides a bearing fill percentage of greater than seventy-five percent.

2. The ball bearing assembly as recited in claim 1, wherein:
the inner ring includes two annular shoulders extending radially outwardly from a remainder of the outer circumferential surface of the inner ring and spaced axially apart, each annular shoulder providing at least a major portion of a separate one of the first and second inner raceways and having a radial height with respect to the remainder of the outer circumferential surface, the radial height having a value of at least forty percent of the ball diameter; and
the outer ring includes two adjacent annular shoulders extending radially inwardly from a remainder of the inner circumferential surface of the outer ring, each annular shoulder providing at least a major portion of a separate one of the first and second outer raceways and having a radial height with respect to the remainder of the inner circumferential surface, or a single annular shoulder extending radially inwardly from a central portion of the inner circumferential surface, providing at least a major portion of both of the first and second outer raceways and having a radial height with respect to the remainder of the inner circumferential surface, the radial height of each one of the two shoulders or the single shoulder of the outer ring having a value of at least forty percent of the ball diameter.

3. The ball bearing assembly as recited in claim 2, wherein the value of each radial height is greater than forty-eight percent of the value of the ball diameter.

4. The ball bearing assembly as recited in claim 1, wherein the value of each contact angle is between forty degrees and sixty degrees.

5. The ball bearing assembly as recited in claim 1, wherein the number of balls of each one of the first and second sets of balls provides a bearing fill percentage of greater than eighty percent.

6. The ball bearing assembly as recited in claim 1, wherein the inner ring includes first and second ring parts, the first ring part providing the first inner raceway and having an outer axial end providing the inner ring first axial end and an opposing inner axial end, the second ring part providing the second inner raceway and having an outer axial end providing the inner ring second axial end and an inner axial end disposed against the inner axial end of the first ring part.

7. The ball bearing assembly as recited in claim 1, wherein the inner ring has a radial thickness between a minimum outside diameter of the outer circumferential surface of the inner ring and the inner circumferential surface of the inner ring, the outer ring has a radial thickness between a maximum inside diameter of the inner circumferential surface of the outer ring and the outer circumferential surface of the outer ring, and a value of each radial thickness is at least two times greater than a value of the ball diameter.

8. The ball bearing assembly as recited in claim 1 wherein each one of the inner ring and the outer ring has a plurality of mounting holes extending axially from one of the first and second axial ends and spaced circumferentially about the centerline, each mounting hole being configured to receive a fastener with clearance or to be threadably engaged by a fastener so as to connect the inner ring with the first member and the outer member with the second member.

9. The bearing assembly as recited in claim 1, wherein each one of the first and second inner raceways and each one of the first and second outer raceways has a radius, a value of each raceway radius being no more than three percent greater than half the value of the ball diameter.

10. The bearing assembly as recited in claim 1, wherein:
the one of the first and second axial ends of the inner ring is disposable against the first member or an intermediate member disposed between the inner ring and the first member when the inner ring is connected with the first member; and
the one of the first and second axial ends of the outer ring being disposable against the second member or an intermediate member disposed between the outer ring and the second member when the outer ring is connected with the second member.

11. An angular contact ball bearing assembly for rotatably coupling a first member and a second member, the ball bearing assembly comprising:
an inner ring having a centerline, opposing first and second axial ends, one of the first and second axial ends being connectable with the first member, an inner circumferential surface and an outer circumferential surface including a first inner raceway and a second inner raceway spaced axially from and facing the first inner raceway;
an outer ring disposed about the inner ring and having opposing first and second axial ends, one of the first and second axial ends being connectable with the second member, an outer circumferential surface and an inner circumferential surface including a first outer raceway and a second outer raceway, the first and second outer raceways being disposed axially between the first and second inner raceways such that the first outer raceway faces the first inner raceway and the second outer raceway faces the second inner raceway; and
a first set of balls disposed between the first inner raceway and the first outer raceway and a second set of balls disposed between the second inner raceway and the second outer raceway, each ball of the first and second sets of balls having a ball diameter;
wherein the inner ring, the outer ring, the first set of balls and the second set of balls are each formed and sized such that a first contact angle between each ball of the first set of balls and the first inner and outer raceways has a value greater than thirty-five degrees and a second contact angle between each ball of the second set of balls and the second inner and outer raceways has a value greater than thirty-five degrees; and
wherein the inner ring includes two annular shoulders extending radially outwardly from a remainder of the outer circumferential surface of the inner ring and spaced axially apart, each annular shoulder providing at least a major portion of a separate one of the first and second inner raceways and having a radial height with respect to the remainder of the outer circumferential surface, the outer ring includes two adjacent annular shoulders extending radially inwardly from a remainder of the inner circumferential surface of the outer ring, each annular shoulder providing at least a major portion of a separate one of the first and second outer raceways and having a radial height with respect to the remainder of the inner circumferential surface, or a single annular shoulder extending radially inwardly from a central portion of the inner circumferential surface, providing both of the first and second outer raceways and having a radial height with respect to the remainder of the inner circumferential surface, each radial height having a value of at least forty percent of the ball diameter.

12. An angular contact ball bearing assembly for rotatably coupling a first member and a second member, the ball bearing assembly comprising:
an inner ring having a centerline, opposing first and second axial ends, one of the first and second axial ends being connectable with the first member, an inner circumferential surface and an outer circumferential surface including a first inner raceway and a second inner raceway spaced axially from and facing the first inner raceway;
an outer ring disposed about the inner ring and having opposing first and second axial ends, one of the first and second axial ends being connectable with the second member, an outer circumferential surface and an inner circumferential surface including a first outer raceway and a second outer raceway, the first and second outer raceways being disposed axially between the first and second inner raceways such that the first outer raceway faces the first inner raceway and the second outer raceway faces the second inner raceway; and
a first set of balls disposed between the first inner raceway and the first outer raceway and a second set of balls disposed between the second inner raceway and the second outer raceway, each ball of the first and second sets of balls having a ball diameter;
wherein the inner ring, the outer ring, the first set of balls and the second set of balls are each formed and sized such that a first contact angle between each ball of the first set of balls and the first inner and outer raceways has a value greater than thirty-five degrees and a second contact angle between each ball of the second set of balls and the second inner and outer raceways has a value greater than thirty-five degrees; and
wherein the inner ring has a radial thickness between a minimum outside diameter of the outer circumferential surface of the inner ring and the inner circumferential surface of the inner ring, the outer ring has a radial thickness between a maximum inside diameter of the inner circumferential surface of the outer ring and the outer circumferential surface of the outer ring, and a value of each radial thickness is at least two times greater than a value of the ball diameter.
